(19) United States
(12) Patent Application Publication
(10) Pub. No.: US 2013/0195184 A1
(43) Pub. Date: Aug. 1, 2013

(54) SCALABLE VIDEO CODING METHOD AND APPARATUS

(71) Applicant: Samsung Electronics Co., Ltd., Gyeonggi-do (KR)

(72) Inventor: Hyeongmin NAM, Gyeonggi-do (KR)

(73) Assignee: Samsung Electronics Co., Ltd., Gyeonggi-do (KR)

(21) Appl. No.: 13/751,637

(22) Filed: Jan. 28, 2013

(30) Foreign Application Priority Data
Jan. 27, 2012 (KR) 10-2012-0008369

(51) Int. Cl. H04N 7/26

(52) U.S. Cl. CPC H04N 19/00569
USPC 375/240.12

(57) ABSTRACT

A scalable video decoding method is provided for extracting a layer of the video bit stream with a decoding level configured selectively according to the layout of the video display screen. The method includes receiving at least one video bit stream composed of at least one layer; determining a decoding level based on a preset screen configuration; extracting the video bit stream layer of the video bit stream according to the decoding level; and decoding the extracted layer. Video bit streams may be selectively decoded so as to save resources, and the decoding level and display screen layout can be adjusted with intuitive manipulation.

### PRIORITY

This application claims priority under 35 U.S.C. §119(a) to a Korean patent application filed on Jan. 27, 2012 in the Korean Intellectual Property Office and assigned Serial No. 10-2012-0008369, the entire disclosure of which is hereby incorporated by reference.

### BACKGROUND OF THE INVENTION

1. Field of the Invention

The present invention generally relates to a method and apparatus of decoding scalable video processing (SVC)-based video bit streams selectively according to a decoding level, And more particularly, to a scalable video decoding method for extracting a layer of the video bit stream with a decoding level selectively configured according to the layout of a video display screen.

2. Description of the Related Art

With the advance of communication and video compression/transmission technologies, video conference systems which make it possible for multiple remote participants to take part in a conference have been replacing legacy voice-based conference systems.

Since video conference systems have to be configured to exchange audio and video among the multiple participants in real time, efficient video and audio streaming and mixing technology is essential. Further, in order for a user to participate in the video conference using a mobile terminal, an enhanced low power video processing technology is required.

FIG. 1 is a schematic diagram illustrating a conventional video conference system. As shown in FIG. 1, the conventional video conference system is provided with a Multipoint Control Unit (MCU) 100.

In FIG. 1, the MCU 100 processes the audio and video received from all participant terminals 110, 120, 130, 140, and 150 to fit for each recipient terminal. This is because the video bit streams A, B, C, D, and E from the terminals 110, 120, 130, 140 and 150 are transmitted without scalability.

Accordingly, the MCU 100 decodes the data of the audio and video bit streams received from the participant terminals, recombines (mixing/composition) the decoded data, and encodes the recombined data to be transmitted to the recipient terminals.

However, the conventional method has a drawback in that the processing load (including decoding, recombination, and encoding) concentrated on the MCU 100 causes processing delays. Furthermore, the conventional method degrades the user experience (UX) of the real time video conference users and increases the operation complexity cost of the MCU.

### SUMMARY OF THE INVENTION

The present invention has been made in an effort to address the above problems and disadvantages, and to provide the advantages described below. Accordingly, it is an aspect of the present invention to provide an SVC-based video bit stream decoding method and apparatus that is capable of saving resources.

It is another aspect of the present invention to provide an SVC-based video bit stream decoding method and apparatus that is capable of changing the decoding level and layout of the display screen through intuitive manipulation.

In accordance with an aspect of the present invention, a selective scalable video decoding method includes receiving at least one video bit stream composed of at least one layer; determining a decoding level based on a preset screen configuration; extracting the video bit stream layer of the video bit stream according to the decoding level; and decoding the extracted layer.

In accordance with another aspect of the present invention, a selective scalable video decoding apparatus includes a communication unit which receives at least one video bit stream composed of at least one layer; a display unit which displays the at least one video bit stream according to a preset screen configuration; an input unit which receives a user input; and a control unit which determines a decoding level based on a preset screen configuration, extracts the video bit stream layer of the video bit stream according to the decoding level, and decodes the extracted layer.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a schematic diagram illustrating the conventional video conference system;

FIG. 2 is a schematic diagram illustrating the network structure of the video conference system based on the scalable video processing (SVC) according to an embodiment of the present invention;

FIG. 3 illustrates the concept of spatial-temporal scalability of an SVC-based video bit stream according to an embodiment of the present invention;

FIG. 4 is a block diagram illustrating the configuration of a selective decoding apparatus according to an embodiment of the present invention;

FIG. 5 illustrates the concept of the spatial-temporal scalability of the SVC-based video bit stream according to an embodiment of the present invention;

FIG. 6 is a flowchart illustrating the procedure for decoding the video bit stream selectively according to an embodiment of the present invention;

FIG. 7 is a flowchart illustrating the details of decoding level determination step of FIG. 6;

FIG. 8 is a diagram illustrating screen layouts for displaying the video bit stream in the scalable video processing apparatus according to an embodiment of the present invention;

FIG. 9 is a diagram illustrating screen images for explaining the screen configuration operations in the scalable video processing apparatus according to an embodiment of the present invention;

FIG. 10 is a diagram illustrating screen images for explaining the screen configuration operations in the scalable video processing apparatus according to another embodiment of the present invention;

FIG. 11 is a diagram illustrating a screen image for explaining a power-saving mode configuration operation in the scalable video processing apparatus according to an embodiment of the present invention; and

FIG. 12 is a diagram illustrating screen images for explaining the screen configuration operations in the scalable video processing apparatus according to another embodiment of the present invention.

### DETAILED DESCRIPTION OF EMBODIMENTS OF THE PRESENT INVENTION

The present invention is not limited to the description of the following embodiments and it is obvious that various modifications can be made without departing from the scope of the technical concept of the present invention. Detailed descriptions of well-known functions and structures incorporated herein may be omitted to avoid obscuring the subject matter of the present invention.

The same reference numbers are used throughout the drawings to refer to the same or like parts. In the drawings, certain elements may be exaggerated or omitted or schematically depicted for clarity of the invention, and the actual sizes of the elements are not reflected. Embodiments of the present invention are described in detail with reference to the accompanying drawings.

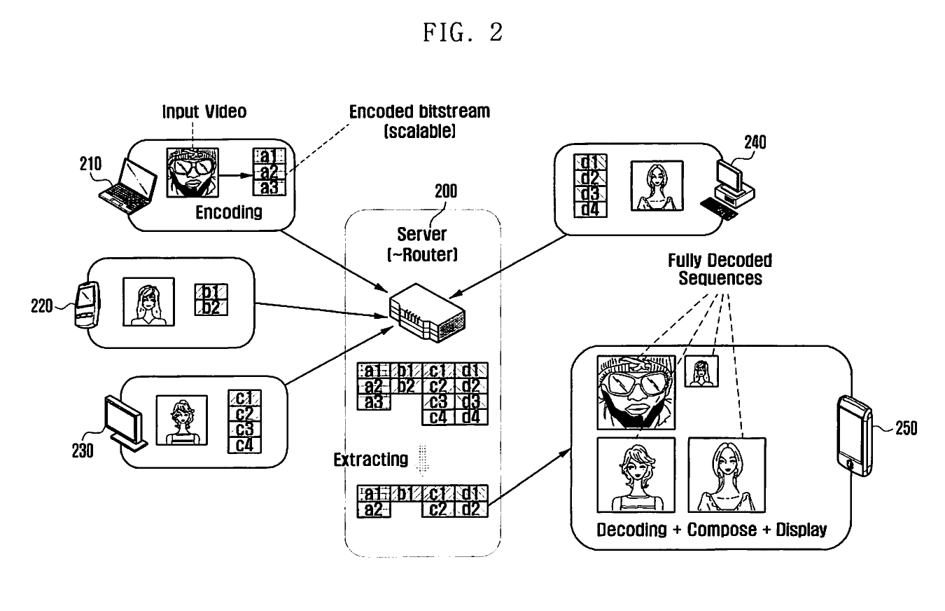

FIG. 2 is a schematic diagram illustrating the network structure of the video conference system based on scalable video processing (SVC) according to an embodiment of the present invention.

H.264/Scalable video processing (SVC) has recently emerged as the video compression standard capable of decoding one compressed bit stream into various resolution/frame-rate/video quality data. As shown in FIG. 2, a video conference system adopting the SVC-based video compression standard includes a server 200 and a plurality terminals 210, 220, 230, 240, and 250 connected to the server 200.

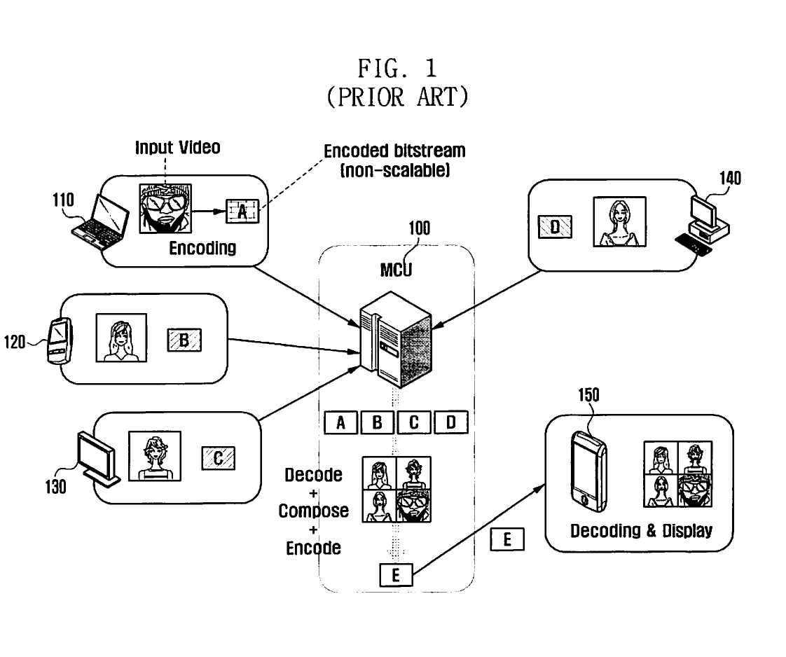

In FIG. 2, the server 200 extracts (crops/extracts) the compressed bit stream and transmits the extracted bit stream according to the status of the recipient terminal. The status includes bandwidth of the network and capability of the recipient terminal. Unlike the conventional MCU 100 of FIG. 1 which operates in decode-compose-encode order, the SVC-based server 200 just extracts (crops/extracts) the compressed bit stream and transmits the extracted data according to the status of the recipient terminals.

Therefore, there is no extra delay caused by decode-compose-encode processing, and the recipient terminal 250 performs selective decoding and composing on the received video data.

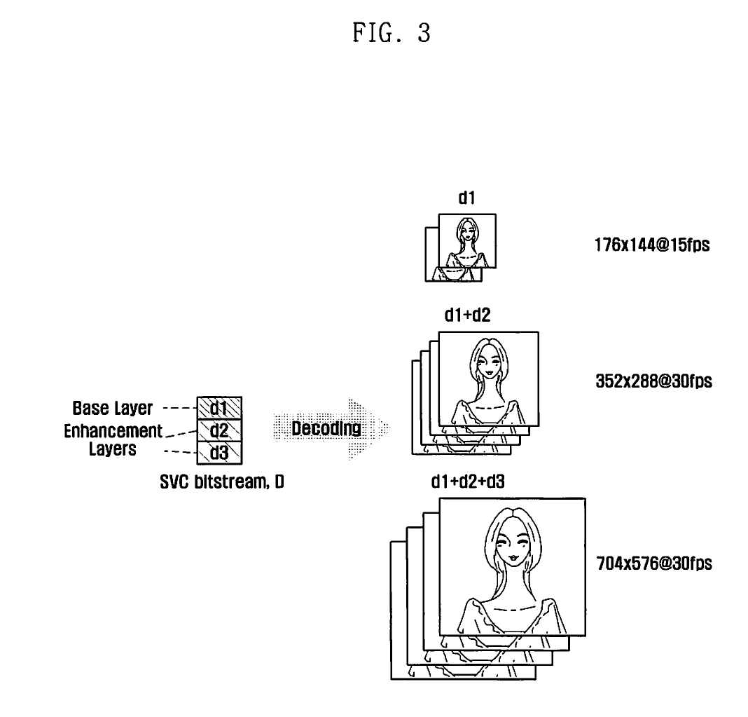

FIG. 3 is a diagram illustrating the concept of spatial-temporal scalability of SVC-based video bit stream according to an embodiment of the present invention.

When using the SVC-based scalable video compression standard, the SVC bit stream D (D=d1+d2+d3) may have a resolution up to 704×576 at 30 frames per second (fps). If d1 and d2 are decoded selectively, 352×288@20 fps video is extracted. Also, if only the Base Layer d1 is decoded, 176×144@15 fps video is extracted. In this way, the SVC bit stream can be decoded by selectively extracting the layers from the bit stream.

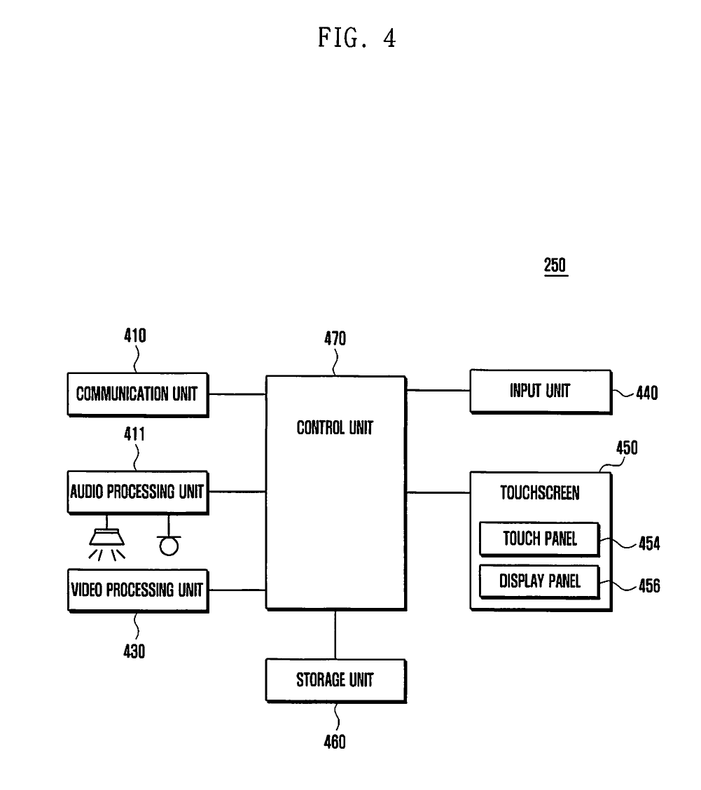

FIG. 4 is a block diagram illustrating the configuration of the selective decoding apparatus according to an embodiment of the present invention. As shown in FIG. 4, the selective decoding apparatus 250 according to an embodiment of the present invention includes a communication unit 410, an audio processing unit 411, a video processing unit 430, an input unit 440, a touchscreen 450, a storage unit 460, and a control unit 470.

The communication unit 410 is responsible for data communication of the decoding apparatus 250 through a wired or wireless channel. The communication unit 410 also receives the data through the wired or wireless channel and transfers the received data to the control unit 470 and transmits the data output by the control unit 470 through the wireless channel. In an embodiment of the present invention, the communication unit 410 receives the video bit stream and audio bit stream from the server 200 of FIG. 2.

The audio processing unit 411 and the video processing unit 430 include codecs such as a data codec for processing packet data and audio and video codecs for processing audio and video signals. In an embodiment of the present invention, the audio and video processing units 411 and 430 decode the audio and video bit streams output by the control unit 470.

The touchscreen 450 includes a touch panel 454 and a display panel 456. The touch panel 454 detects the touch input made by the user and generates an input signal to the control unit 470. The input signal includes coordinates of the touch point position where the touch input is detected. If the user drags the touch point, the touch panel 454 generates the touch signal including the coordinates on the dragging path to the control unit 470.

In an embodiment of the present invention, the touch panel 454 detects the user input for configuring the display screen or for transitioning to a power-saving mode. Such a user input can be made by a touch (multi-touch) or a drag gesture.

The display panel 456 can be implemented with one of Liquid Crystal Display (LCD), Organic Light Emitting Diodes (OLED), and Active Matrix Organic Light Emitting Diodes (AMOLED), and displays menus of the decoding apparatus 250, input data, function-setting information, and other information to the user. In an embodiment of the present invention, the display panel 456 displays the video bit stream screen according to the preset layout.

Although the description is directed to the decoding apparatus equipped with a touchscreen, the present invention is not limited to the touchscreen-enabled decoding apparatus. When the present invention is applied to a decoding apparatus having no touchscreen, the touchscreen 450 can be configured only with the function of the display panel 456.

The input unit 440 receives the key manipulations made by a user for controlling the decoding apparatus 250 and generates an input signal to the control unit 470. The decoding apparatus 250 according to an embodiment of the present invention is configured so as to be wholly manipulated by means of the touch panel 454. In this case, the touch panel 454 operates as a part of the input unit 440.

The storage unit 460 stores the programs and data associated with the operations of the decoding apparatus 250 and can be divided into a program region and a data region. The program region stores the Operating System (OS) for controlling the overall operations of the decoding apparatus 250 and booting up the decoding apparatus 250 and application programs for playing multimedia content and executing other supplementary functions such as a camera function, sound playback function, and still and motion picture playback functions. The data region stores the data generated in using the decoding apparatus such as still and motion pictures, a phonebook, and audio data.

The control unit 470 controls the overall operations of the components of the decoding apparatus. In an embodiment of the present invention, the control unit 410 controls the procedure for the decoding apparatus 250 to receive the scalable video bit stream and selectively decode the bit stream.

The control unit 470 determines the decoding level when the video bit stream is received through the communication unit 410. The control unit 470 determines the decoding level based on at least one of a preset layout, power-saving mode activation/deactivation, and voice activity; and the detailed determination procedure is described below with reference to accompanying drawings.

Once the decoding level has been determined, the control unit 470 determines Frame Size (FS) and Frame Rate (FR), extracts a layer of the bit stream based on the FS and the FR, and sends the extracted signal to the video processing unit 430. The video processing unit 430 performs decoding on the layer extracted according to the signal from the controller 470.

The control unit 470 controls the display unit 456 to display the video bit stream decoded by the video processing unit 430 on the display screen according to the layout. The layout can be changed in response to a user command input though the input unit 440, and the layout change procedure is described below in detail with reference to accompanying drawings.

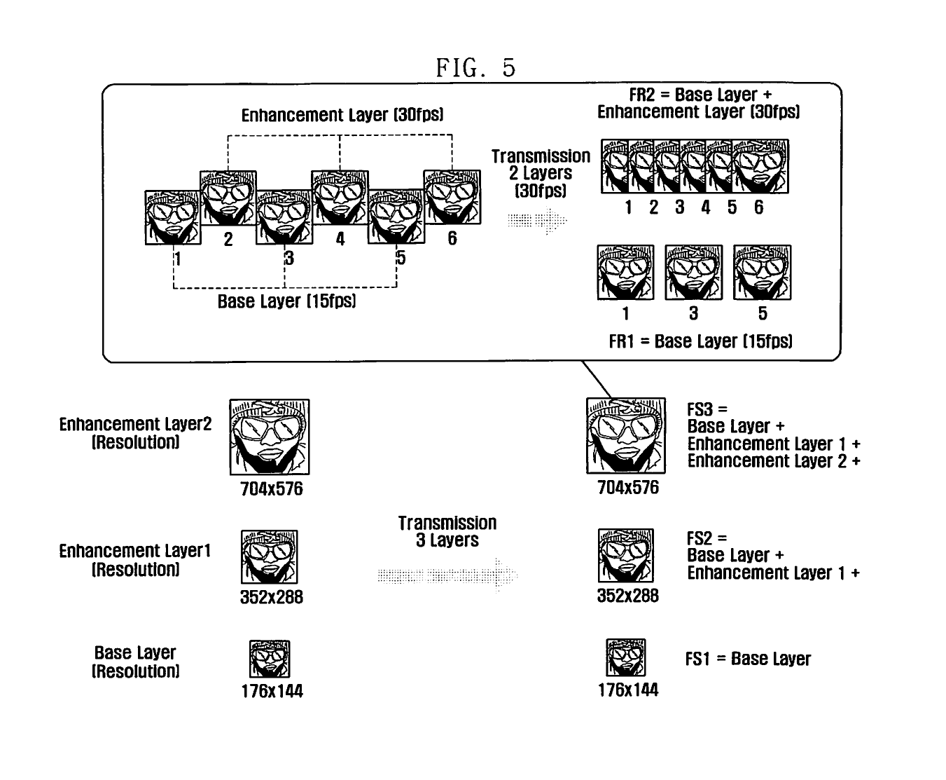

FIG. 5 illustrates the concept of the spatial-temporal scalability of the SVC-based video bit stream according to an embodiment of the present invention. According to an embodiment of the present invention, the video bit stream can support the scalability based on Frame Size (FS) and Frame Rate (FR).

For example, assuming that the received video bit stream is Bi (i=1, 2, 3, . . . , K, K=number of received video bit streams), each video bit stream Bi can be expressed as Bi(FRn, FSm) according to the current FS and FR.

Here, the supportable frame rate level FRn=Framerate (n=1, 2, 3, . . . , Ni), and the supportable frame size level FSm=Framesize (m=1, 2, 3, . . . , Mi). Here, Ni and Mi denotes the maximum resolution and frame rate level of each video bit stream Bi.

As shown in FIG. 5, the frame rate can include FR1=15 Hz (15 frames per second) and FR2=30 Hz (30 frames per second); and the frame size can include FS1=176×144, FS2=352×288, and FS3=704×576. Accordingly, if Bi(FR2, FS2) is extracted, the user can see an image of 353×288@30 fps.

Ci(FRn, FSm) denotes the operation complexity for decoding the Bi into FRn and FSm. Since the decoding complexity is proportional to the frame size and frame rate, the Ci(FRn, FSm) can be calculated using Equation (1) as follows.

Ci(FRn, FSm)=a*Frame Width of FSm*Frame Height of FSm*Framerate of FRn/(Max Frame width*Max Frame height*Max Framerate)+b (1)

In Equation (1), a and b are experimental values. If n=1, m=1, a=1, and b=0; the Ci is 176*144*15/704*576*30 in FIG. 5. The Ci can be measured with a conventional method which is a little complex but a little accurate as compared to the above method.

Assuming that the power same value selected by the user with a scroll bar or a button is P (P=0.1˜1), the total complexity limit can be CLimit=CT*P=sum(Ci(FRN, FSM))*P. Accordingly, if the user sets P to 0.5, the control unit 470 determines the decoding level to extract the layer of the bit stream corresponding to ½ of the complexity required for decoding the whole video bit stream.

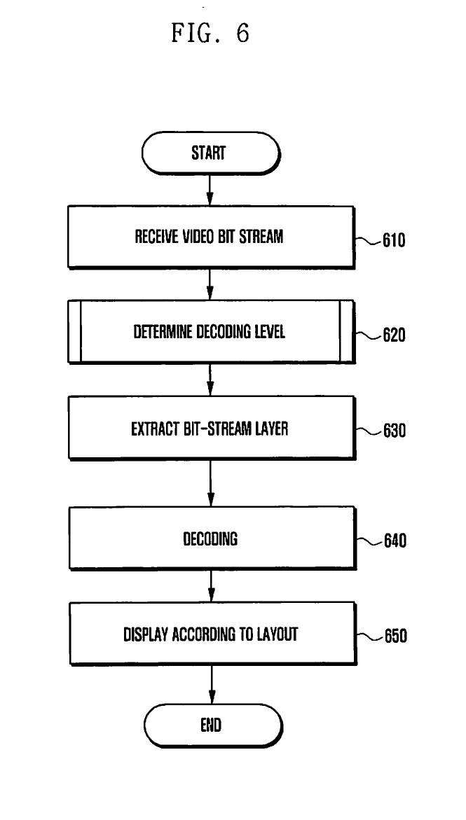

FIG. 6 is a flowchart illustrating the procedure for decoding the video bit stream selectively according to an embodiment of the present invention.

The communication unit 410 receives the SVC-based video and audio bit streams from the server 200 at step 610.

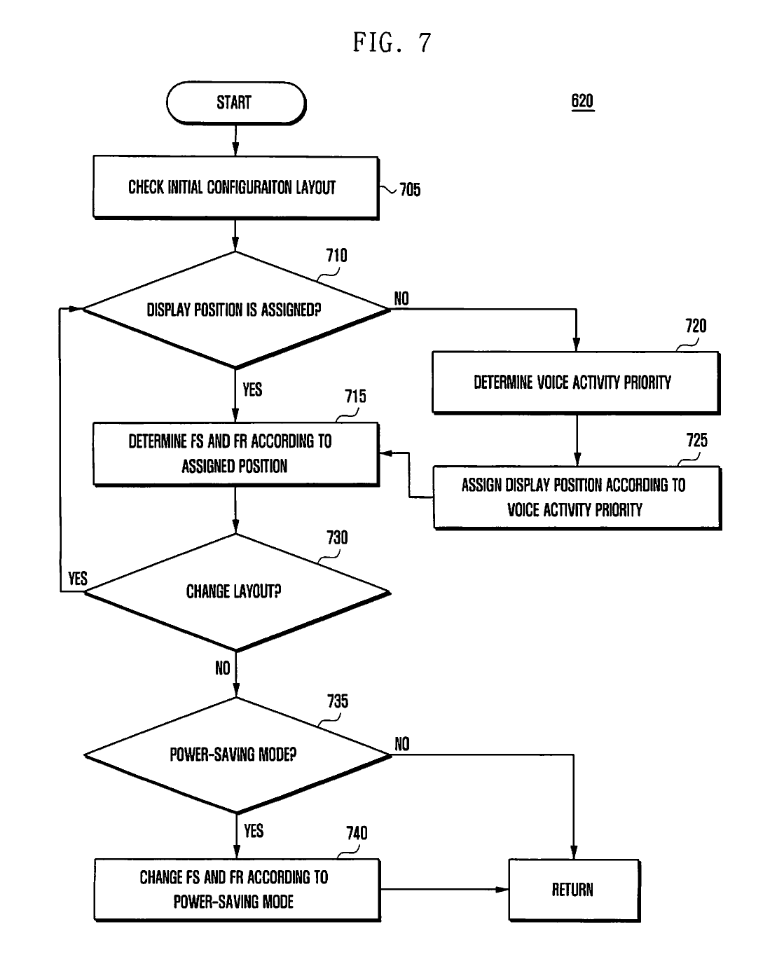

The control unit 470 determines the decoding level of the received video bit stream at step 620. The details of step 620 are depicted in FIG. 7.

FIG. 7 is a flowchart illustrating the details of decoding level determination procedure of step 620 of FIG. 6.

The control unit 470 checks the preconfigured layout at step 705. The layout expressing the video bit stream is determined by the control unit 470 according to the number of received video bit streams or by user input. A configuration of the layout is described below with reference to accompanying drawings.

The control unit 470 determines whether positions for presenting the respective video bit streams have been assigned in the layout at step 710. That is, the control unit 470 determines whether the user has designated the video bit stream presentation positions.

If the presentation positions have been assigned, the control unit 470 determines the frame size and frame rate corresponding to each position according to the size of the position at step 715. In detail, assuming that the layout size assigned for a video bit stream is RSi, if the RSi is greater than FS of the Bi, the control unit 470 reduces the FS level and, while the condition of (sum(Ci(FRn, FSm))<CLimit) is fulfilled, stops extraction.

If no presentation position is assigned at step 710, the control unit 470 detects the voice signal of the audio bit streams associated with the respective video bit streams to determine the priority of the voice activities, i.e. voice signal appearance frequency. In detail, the audio processing unit 411 decodes the audio bit streams, or the control unit 470 discriminates between the received audio packet types, i.e. real voice packet and mute or noise packet to determine an active speaker.

Afterward, the control unit 470 assigns the presentation positions of the respective video bit streams in the preconfigured layout according to the voice activity priorities at step 725 and determines the frame sizes and frame rates at the assigned positions at step 715.

At step 730, it is determined whether a change of the preconfigured layout occurs. If a user input is detected, the control unit 470 determines whether the user input is a layout change command at step 730.

According to an embodiment of the present invention, the layout change may include a change in number of windows, window size, and/or presentation order; and the detailed procedure of layout change is described below with reference to accompanying drawings.

It the user input is the layout change command, the procedure goes back to step 710 to assign the presentation positions of the respective video bit streams according to the changed layout, and determines the frame sizes and frame rates of the assigned positions at step 715.

If no change is detected at step 730, it is determined whether the decoding apparatus 250 enters the power saving mode at step 735. If a user input is detected, the control unit 470 determines whether the user input is a power saving mode entry command at step 735. The detail of the user input for power saving mode entry is described below with reference to accompanying drawings.

If the user input is the power saving mode entry command, the control unit 470 changes the frame size and frame rate of each video bit stream at step 740, according to the power saving mode. If there is no power saving mode entry command, the process returns to step 620 of FIG. 6.

Returning to FIG. 6, the control unit 470 extracts the layer of the bit stream according to the decoding level at step 630 and transmits a signal to control the video processing unit 430 to decode the extracted layer at step 640.

Finally, the control unit 470 transmits a signal to control the display panel 456 to display the decoded video bit streams at step 650.

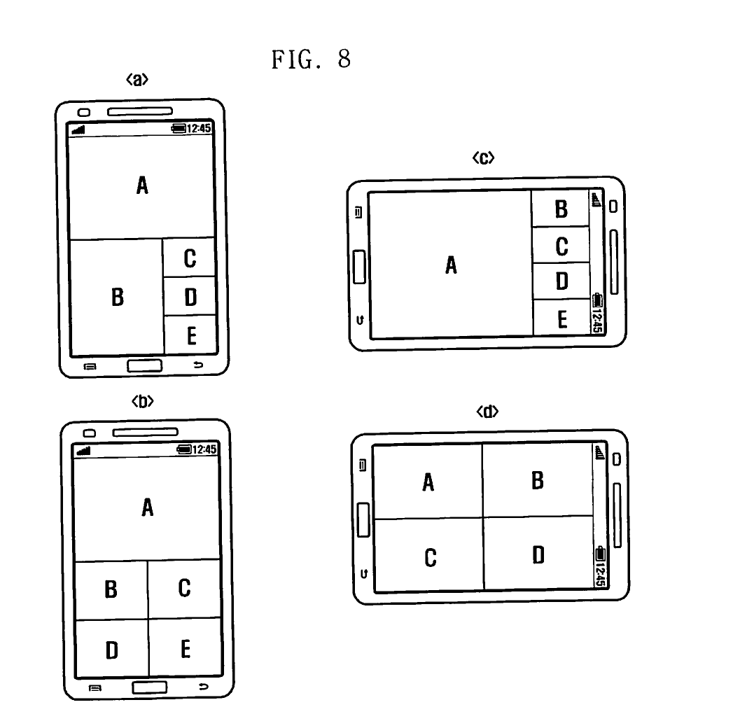

FIG. 8 is a diagram illustrating screen layouts for displaying the video bit stream in the scalable video processing apparatus according to an embodiment of the present invention.

Parts (a), (b), and (c) of FIG. 8 show screens in which each are divided into 5 sections, and part (d) of FIG. 8 shows a screen divided into 4 sections.

As described above, the video bit streams can be assigned to the respective sections, and the control unit 470 can assign the sections to the video bit streams according to the voice activity levels of audio bit streams associated with the respective video bit streams. In this case, the sections are assigned in largest-first order to the video bit streams in descending order of voice activity. The sections having the same size are assigned on a first come first served basis.

When the video bit streams are assigned the respective sections according to the voice activity, the control unit 470 can change the sections assigned to the video bit streams based on a changed order of voice activity.

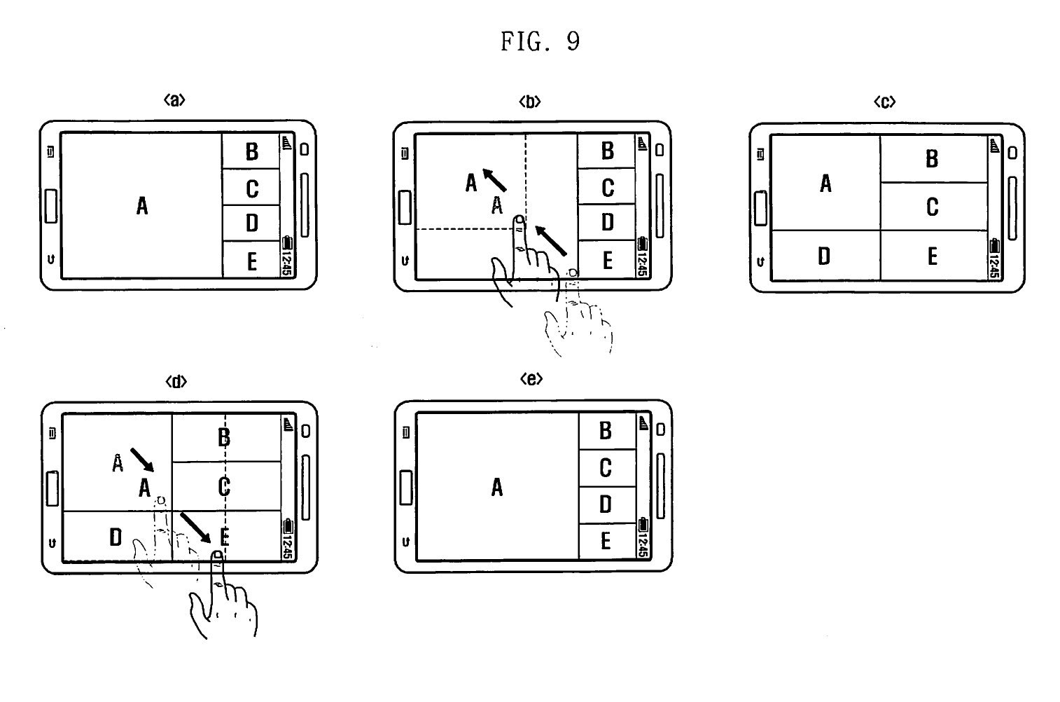

FIG. 9 is a diagram illustrating screen images for explaining the screen configuration operations in the scalable video processing apparatus according to an embodiment of the present invention. In detail, FIG. 9 shows the operations of increasing/decreasing the sizes of sections.

In the state in which the initial display screen is configured as shown in part (a) of FIG. 9, the user is capable of dragging a boundary line of the sections to decrease the size of the largest section as shown in part (b) of FIG. 9. If a user makes a touch on a section boundary and drags the touch in an inward direction of the section, the control unit 470 regards this as a size reduction command. If the size reduction command is input, the control unit 470 changes the decoding levels of the video bit streams according to the changed layout such that the decoded bit streams are displayed in the corresponding resized sections as shown in part (c) of FIG. 9.

Part (d) of FIG. 9 shows a gesture for inputting a size enlargement command. If the user makes a touch on a section boundary and drags the touch in an outward direction of the section, the control unit 470 regards this gesture as the size enlargement command. If the size enlargement command is input as shown in part (d) of FIG. 9, the control unit 470 changes the layout as shown in part (e) of FIG. 9.

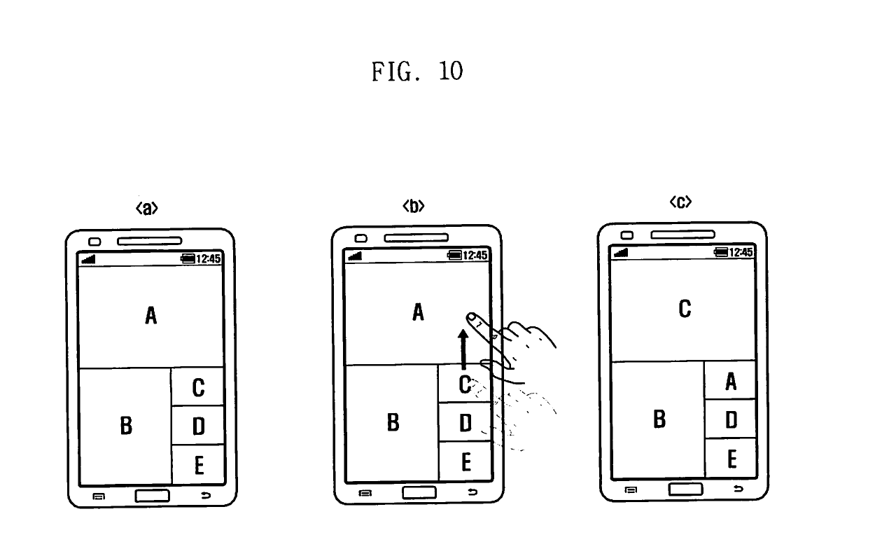

FIG. 10 is a diagram illustrating screen images for explaining the screen configuration operations in the scalable video processing apparatus according to another embodiment of the present invention. In detail, FIG. 10 shows the operations of switching sections.

In the state in which the initial display screen is configured as shown in part (a) of FIG. 10, the user is capable of switching the sections C and A. If the user makes a touch on the section C and drags the touch to the section A as shown in part (b) of FIG. 10, the control unit 470 regards this gesture as a section switching command.

If the section switching command is detected, the control unit 470 reconfigures the layout as shown in part (c) of FIG. 10.

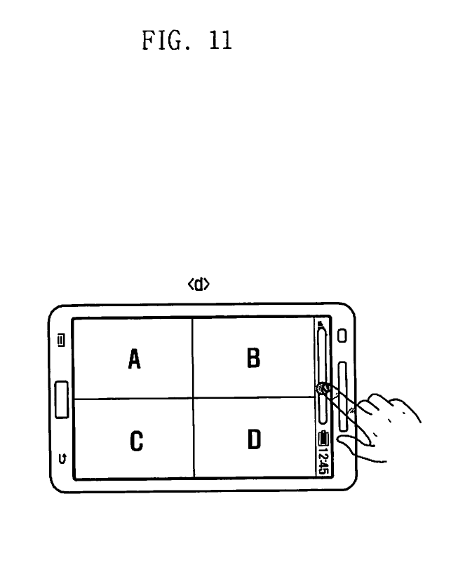

FIG. 11 is a diagram illustrating a screen image for explaining the power-saving mode configuration operation in the scalable video processing apparatus according to an embodiment of the present invention.

As shown in FIG. 11, the power-saving mode can be enabled by manipulating a scroll bar presented on the display screen. The power-saving mode also can be enabled with a button of the input unit 440.

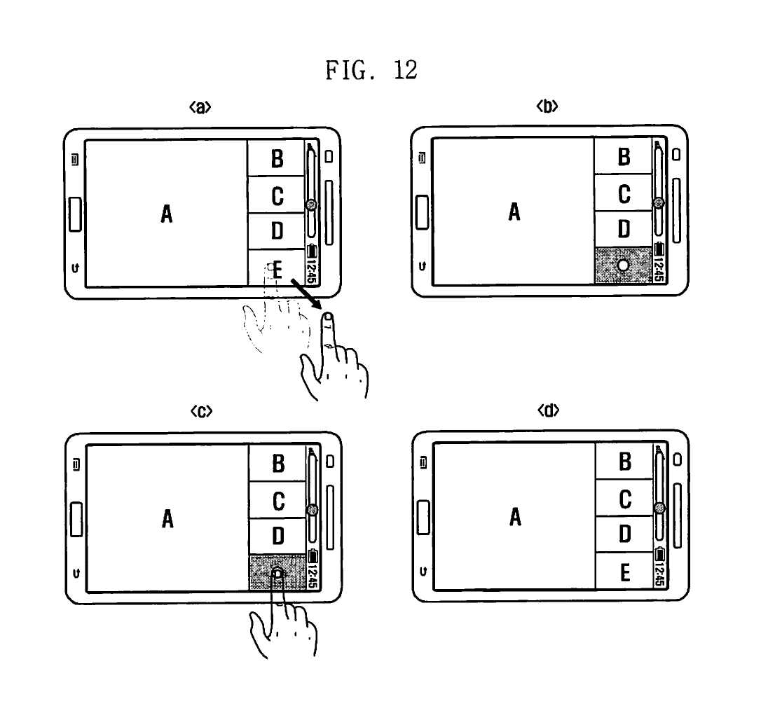

FIG. 12 is a diagram illustrating screen images for explaining the screen configuration operations in the scalable video processing apparatus according to another embodiment of the present invention. In detail, FIG. 12 shows the operations of hiding and showing the video in a section.

Part (a) of FIG. 12 shows a user input gesture for hiding the video in a section. If the user makes a touch on section E and then makes a gesture in which the user flicks out of the screen, the control unit 470 regards this gesture as the video hide command.

If the video hide command is input, the control unit 470 controls to stop decoding the video bit stream assigned to section E such that the section E is blanked out as shown in part (b) of FIG. 12.

Part (c) of FIG. 12 shows a user input gesture for showing the video in a section. If the user makes a touch on the blanked section and maintains the touch over predetermined time duration, the control unit 470 regards this gesture as a video show command. If the video show command is detected on the blanked section E, the control unit 470 controls to restart decoding the video bit stream assigned section E such that the video bit stream is displayed in section E, as shown in part (d) of FIG. 12.

As described above, the scalable video processing method and apparatus of the present invention is capable of determining the decoding level according to the user selection or voice activity, resulting in a reduction of resource waste.

Also, the scalable video processing method and apparatus of the present invention is capable of adjusting the decoding level and display screen layout with intuitive manipulation, and capable of applying manipulation for adjusting the decoding process immediately, resulting in improvement of user convenience.

Although certain embodiments of the present invention have been described in detail hereinabove with specific terminology, this is for the purpose of describing particular embodiments only and not intended to be limiting of the invention. While particular embodiments of the present invention have been illustrated and described, it would be obvious to those skilled in the art that various other changes and modifications can be made without departing from the spirit and scope of the invention.

What is claimed is:

1. A selective scalable video decoding method, the method comprising:
receiving at least one video bit stream composed of at least one layer;
determining a decoding level based on a preset screen configuration;
extracting the video bit stream layer of the video bit stream according to the decoding level; and
decoding the extracted layer.

2. The method of claim 1, further comprising displaying, after decoding the extracted layer, the decoded video bit streams on a screen according to the preset screen configuration.

3. The method of claim 2, wherein determining the decoding level comprises determining, when a section for the video bit stream has been assigned in the screen configuration, the decoding level of the video bit stream according to a size of the assigned section.

4. The method of claim 3, wherein determining the decoding level comprises extracting, when a section for the video bit stream has not been assigned in the screen configuration, a voice signal from an audio bit stream associated with the video bit stream and determining the decoding level of the video bit stream according to a voice signal appearance frequency.

5. The method of claim 4, wherein displaying the decoded video bit streams comprises:
assigning a section to the video bit stream in the screen configuration according to the decoding level; and
displaying the decoded video bit stream in the section of the screen according to the size of the section.

6. The method of claim 1, wherein determining the decoding level comprises:
resetting the screen configuration in response to a user input; and
changing the decoding level according to the reset screen configuration.

7. The method of claim 6, wherein resetting the screen configuration comprises reconfiguring at least one of a number of screen sections, sizes of section, and presentation order.

8. The method of claim 1, wherein determining the decoding level comprises:
receiving a user input for configuring a power-saving mode of an apparatus for decoding the video bit stream; and
changing the decoding level according to the power saving mode.

9. A selective scalable video decoding apparatus, the apparatus comprising:
a communication unit which receives at least one video bit stream composed of at least one layer;
a display unit which displays the at least one video bit stream according to a preset screen configuration;
an input unit which receives a user input; and
a control unit which determines a decoding level based on a preset screen configuration, extracts the video bit stream layer of the video bit stream according to the decoding level, and decodes the extracted layer.

10. The apparatus of claim 9, wherein the control unit controls the display unit to display the decoded video bit streams on the screen according to the preset screen configuration.

11. The apparatus of claim 10, wherein the control unit determines, when a section for the video bit stream has been assigned in the screen configuration, the decoding level of the video bit stream according to a size of the assigned section.

12. The apparatus of claim 11, wherein the control unit extracts, when a section for the video bit stream has not been assigned in the screen configuration, a voice signal from an audio bit stream associated with the video bit stream and determines the decoding level of the video bit stream according to a voice signal appearance frequency.

13. The apparatus of claim 12, wherein the control unit assigns a section to the video bit stream in the screen configuration according to the decoding level and displays the decoded video bit stream in the section of the screen according to the size of the section.

14. The apparatus of claim 9, wherein the control unit resets the screen configuration in response to a user input and changes the decoding level according to the reset screen configuration.

15. The apparatus of claim 14, wherein the control unit reconfigures at least one of a number of screen sections, sizes of section, and presentation order.

16. The apparatus of claim 9, wherein the control unit determines whether the user input is received through the input unit is for configuring a power-saving mode of an apparatus and changes the decoding level according to the power saving mode.
